(19) United States
(12) Patent Application Publication
(10) Pub. No.: US 2007/0147231 A1
(43) Pub. Date: Jun. 28, 2007

(54) Path protection method and layer-2 switch

(75) Inventors: Taku Yoshida, Fukuoka (JP); Hironori Kadota, Fukuoka (JP); Yoko Toyozumi, Fukuoka (JP); Yumiko Ogata, Fukuoka (JP); Yoshiyuki Maeda, Fukuoka (JP); Hiromu Yoshii, Fukuoka (JP); Yoshiko Sakamoto, Fukuoka (JP); Seiji Miyata, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/388,825

(22) Filed: Mar. 24, 2006

(30) Foreign Application Priority Data
Dec. 28, 2005 (JP) 2005-378371

(51) Int. Cl. H04J 1/16; G08C 15/00; H04J 3/14; H04L 12/26

(52) U.S. Cl. 370/216; 370/242

(57) ABSTRACT

A path protection method is disclosed that is capable of path protection without extra cost and able to improve path switching efficiency. The method includes the steps of associating a virtual network identifier assigned to one or more users with a virtual network identifier for management, the virtual network identifier assigned to one or more users being regarded as one path to set a path for current use and a spare path; and when switching the currently-used path and the spare path, according to service class information included in the virtual network identifier for management, a path corresponding to a virtual network identifier for management having a higher service class than other paths is preferentially switched to.

### BACKGROUND OF THE INVENTION

1. Field of the Invention

The present invention relates to a path protection method and a layer-2 switch, and particularly, to a path protection method and a layer-2 switch in a network.

2. Description of the Related Art

A bridge network is primarily used in a LAN (Local Area Network). In recent years, the bridge network has also been used in carrier networks, hence, it is also being called “Broadband Ethernet” (Registered Trademark).

When being used in the carrier networks, it is required that the bridge network, the devices constituting the bridge network, and links between these devices be of high fault-tolerance.

For this purpose, structures of various levels of redundancy are being introduced, for example, redundant line cards and redundant control cards in the devices, redundant links between the devices, and path control by collecting network topology through redundant protocols.

In the related art, when providing redundancy between one end and another end in the bridge network, the bridge network is constructed by using layer-2 switches in conformity with the Spanning Tree Protocol (a standard before 2004) or the Rapid Spanning Tree Protocol (a standard since 2004) defined in IEEE 802.ID.

Below, for simplicity, the “Rapid Spanning Tree Protocol” is simply called “Spanning Tree Protocol”. In addition, since functions of the Spanning Tree Protocol are included in the Rapid Spanning Tree Protocol, functions of only one of the protocols are described below.

FIG. 1 is a block diagram showing an example of the bridge network in the related art.

In FIG. 1, a switch 1 through a switch 6 are layer-2 switches, whereby a bridge network is constructed. The switch 1 and the switch 6 are connected to user terminals or to a user network, which is not managed from the side of the bridge network, and are located at ends of the bridge network; hence, they are referred to as “end nodes”. On the other hand, the switch 2, switch 3, switch 4, and the switch 5 are not connected to outside terminals, but just relay traffic through the bridge network. Hence, they are referred to as “relay nodes”.

In the bridge network, when the Spanning Tree Protocol is activated to perform path control, as shown in FIG. 1, blocking ports BP1, BP2, and BP3 are provided at positions where a physical loop is formed at ports between the switches. Hence, it is possible to set the blocking ports such that frames other than those used by the Spanning Tree Protocol cannot be transmitted. As a result, theoretically, a network topology without a loop can be constructed.

FIG. 2 is a block diagram showing another example of the bridge network in the related art.

As shown in FIG. 2, when trouble occurs in the link between the switch 2 and the switch 3, since a physical loop does not exist, the blocking port BP3 becomes a forwarding port, and thus switches the path.

Japanese Laid-Open Patent Application No. 2003-158539 discloses a technique in this field. As disclosed in this reference, plural nodes communicating with each other are connected through plural virtual networks in which the paths do not constitute loops. Further, under usual conditions, packets are transmitted by using the plural virtual networks, and when trouble occurs in some of the virtual networks, the packets that ought to be transmitted to the virtual network in trouble are directed through other virtual networks. In addition, two of the virtual networks without paths overlapping in the middle way form one set of virtual networks. When in operation, one of the virtual networks is for current operations, and the other virtual network is a spare for protection. When the virtual network for current use is in trouble, that virtual network is replaced by the spare virtual network.

However, problems arise when using a redundant protocol such as the Spanning Tree Protocol in the bridge network.

First, it is necessary to activate the same redundant protocol with all the layer-2 switches constituting the bridge network, and hence it is difficult to incorporate the layer-2 switches into existing networks.

Second, generally, the layer-2 switches supporting the redundant protocols are expensive, and the cost of the equipment is high.

Third, the redundant protocols are controlled by software, so that when updating this software, the path has to be switched by using other layer-2 switches, and in this case, the primary signal may be affected.

Fourth, even when a VLAN tag is used, which has been standardized in IEEE 802.1Q, since the network topology is not constructed in units of the VLAN tag, the traffic is concentrated in one path.

Fifth, usually, it may require a time period of the order of seconds to detect and recover from trouble in a network. Especially, in the original Spanning Tree Protocol, it may require a time period of the order of a few tens of seconds.

Sixth, the port serving as a blocking port does not transmit traffic. Thus, the blocking port cannot be used in workload distribution.

### SUMMARY OF THE INVENTION

It is a general object of the present invention to solve one or more of the problems of the related art.

It is a more specific object of the present invention to provide a path protection method and a layer-2 switch capable of path protection without extra cost, and able to improve path switching efficiency.

According to a first aspect of the present invention, there is provided a path protection method used in switching a currently-used path and a spare path in an interval in point-to-point connection in a virtual network, comprising the steps of:

associating a virtual network identifier assigned to one or more users with a virtual network identifier for management, said virtual network identifier assigned to one or more users being regarded as one path to allow setting of a path for current use and a spare path; and

when switching the currently-used path and the spare path, according to service class information included in the virtual network identifier for management, a path corresponding to a virtual network identifier for management having a higher service class than other paths is preferentially switched to.

As a second aspect of the present invention, there is provided a path protection method used in switching a currently-used path and a spare path in an interval in point-to-point connection in a virtual network, comprising the steps of: associating a virtual network identifier assigned to one or more users with a virtual network identifier for management, said virtual network identifier assigned to one or more users being regarded as one path to allow setting of a path for current use and a spare path; and when switching the currently-used path and the spare path, a path having a larger number of virtual network identifiers associated with the virtual network identifier for management is preferentially switched to.

As a third aspect of the present invention, there is provided a layer-2 switch, comprising: a control frame generation unit configured to generate a control frame and send the same to a currently-used path and a spare path, said control frame having a virtual network identifier for management, and a virtual network identifier assigned to one or more users being associated with a virtual network identifier for management so as to be regarded as one path; and

a switching unit configured to check communications between the currently-used path and the spare path by receiving the control frame, and to switch the currently-used path to the spare path when trouble is detected in the currently-used path,

wherein

according to service class information included in the control frame, the switching unit preferentially switches to a path corresponding to a virtual network identifier for management having a higher service class than other paths.

As a fourth aspect of the present invention, there is provided a layer-2 switch, comprising:

a control frame generation unit configured to generate a control frame and send the same to a currently-used path and a spare path, said control frame having a virtual network identifier for management, the virtual network identifier assigned to one or more users being associated with a virtual network identifier for management so as to be regarded as one path; and

a switching unit configured to check communications between the currently-used path and the spare path by receiving the control frame, and to switch the currently-used path to the spare path when trouble is detected in the currently-used path,

wherein

when switching the currently-used path and the spare path, the switching unit preferentially switches to a path having a larger number of virtual network identifiers associated with the virtual network identifier for management.

As an embodiment, the layer-2 switch further comprises a service class management table including a virtual network identifier for management extracted from the received control frame and the service class information.

As an embodiment, the layer-2 switch further comprises a virtual network identifier management table including the number of the virtual network identifiers associated with the virtual network identifier for management.

As an embodiment, the control frame includes a control protocol.

As an embodiment, the switching unit sends out the control frame at regular intervals to check communications.

As an embodiment, the switching unit detects the trouble in the currently-used path when the switching unit fails to receive the control frame from the currently-used path and the spare path for a predetermined number of reception operations.

According to the present invention, it is possible to provide a path protection method and a layer-2 switch capable of path protection without extra cost, and to improve path switching efficiency.

These and other objects, features, and advantages of the present invention will become more apparent from the following detailed description of the preferred embodiments given with reference to the accompanying drawings.

### BRIEF DESCRIPTION OF THE DRAWINGS

FIG. 1 is a block diagram showing an example of the bridge network in the related art;

FIG. 2 is a block diagram showing another example of the bridge network in the related art;

FIG. 3 is a block diagram illustrating a configuration of a network according to an embodiment of the present invention;

FIG. 4 is a diagram illustrating the path protection method according to the embodiment of the present invention;

FIG. 5 is a block diagram illustrating a configuration of an edge node according to the present embodiment.

FIG. 6 is a block diagram illustrating a configuration of the VGPP processor 35 according to the present embodiment;

FIG. 7 exemplifies a VGPP management table 42A;

FIG. 8 exemplifies a COS management table 42A;

FIG. 9 exemplifies a VGPP-ID conversion table;

FIG. 10 is a table illustrating a format of the control frame;

FIG. 11 is a sequence diagram illustrating registration of VGPP;

FIG. 12 is a sequence diagram illustrating reception of the control frame;

FIG. 13 is a sequence diagram illustrating path switching according to the present embodiment;

FIG. 14 is a sequence diagram exemplifying transmission of the control frame;

FIG. 15 is a sequence diagram illustrating setting the VGPP management table in VGPP registration; and

FIG. 16 is a sequence diagram illustrating path switching according to a second embodiment of the present invention.

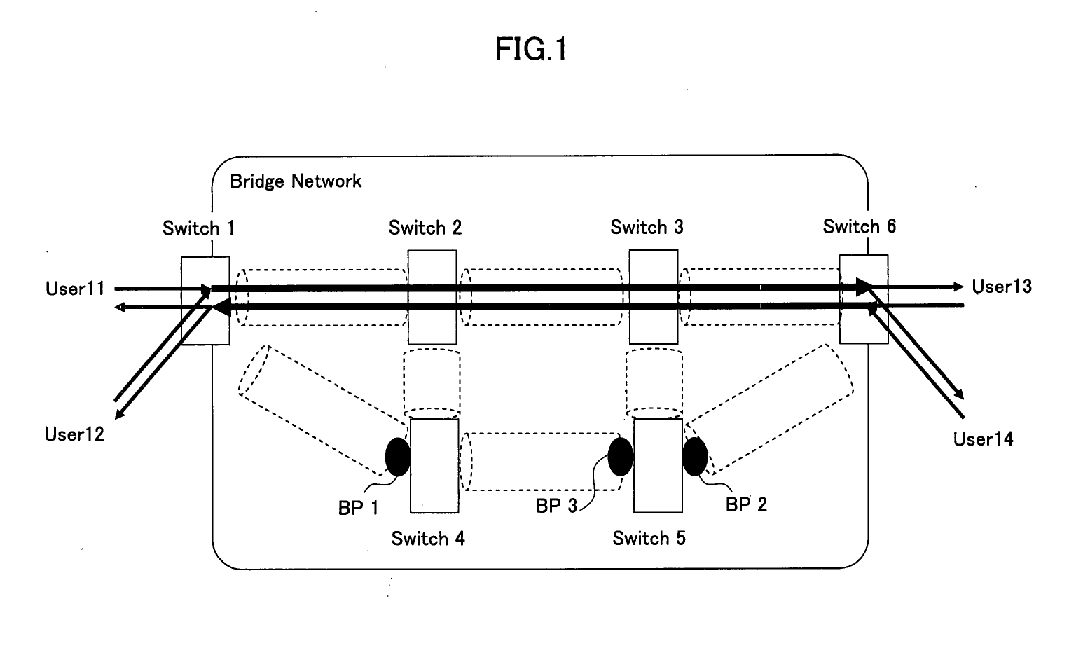

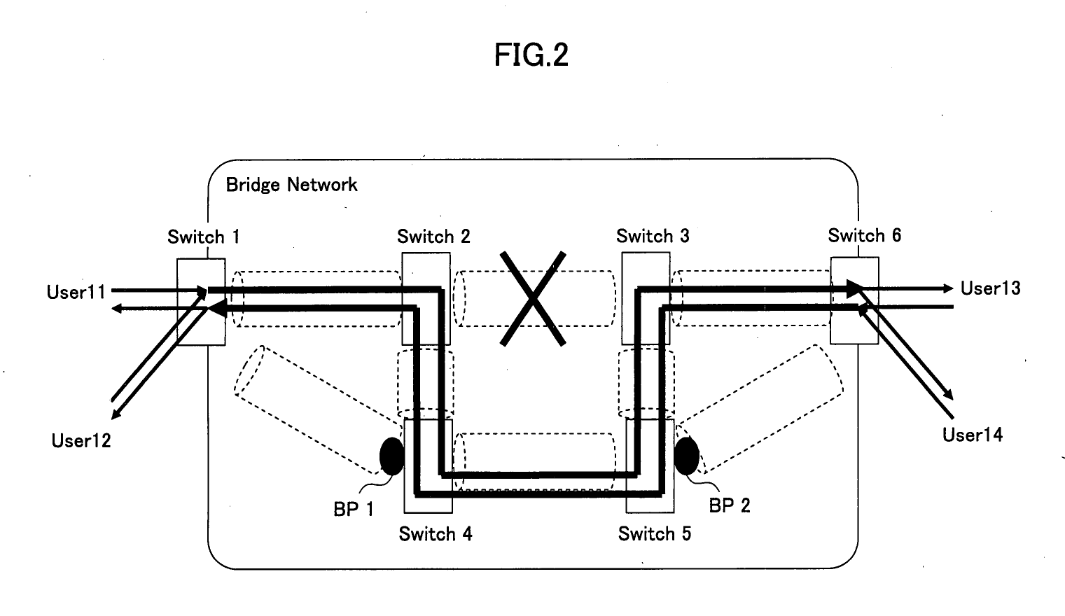

### DESCRIPTION OF THE PREFERRED EMBODIMENTS

Below, preferred embodiments of the present invention are explained with reference to the accompanying drawings.

Network Configuration

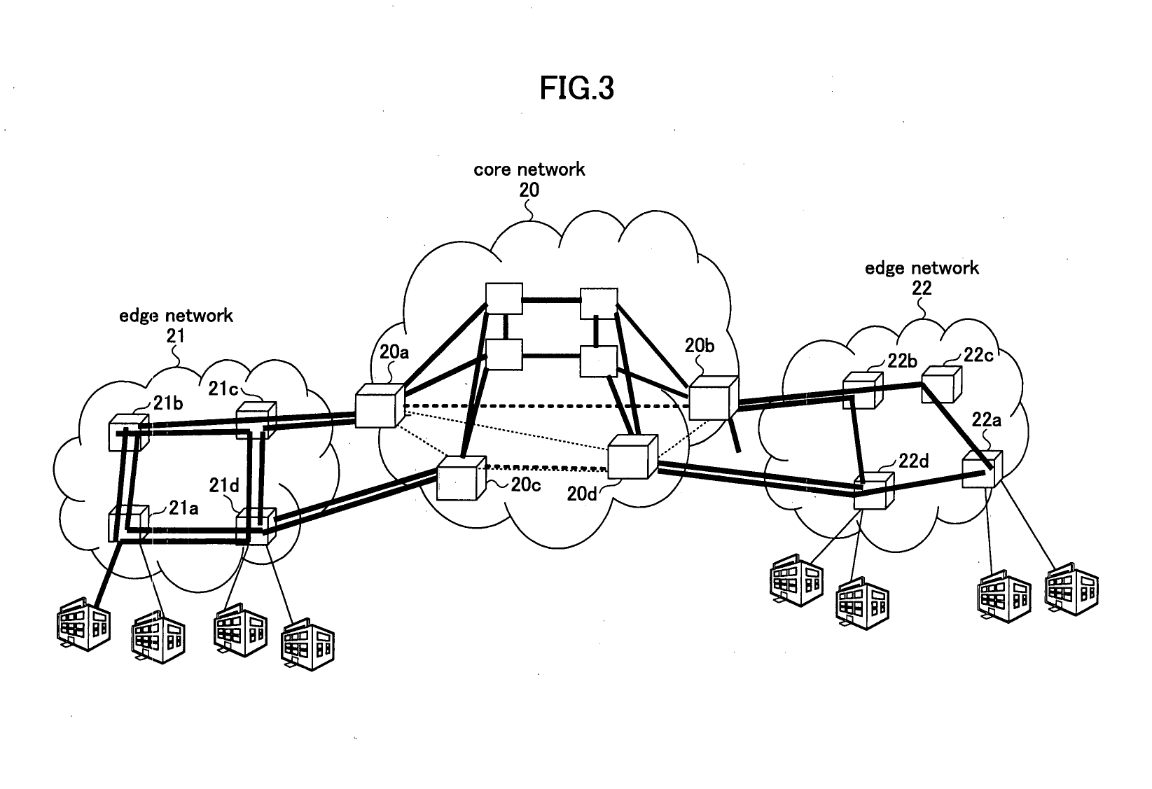

FIG. 3 is a block diagram illustrating a configuration of a network according to an embodiment of the present invention.

In FIG. 3, a core network 20 includes multiple MPLS (Multiprotocol Label Switching) switches, and edge networks 21 and 22 are connected to the core network 20. Each of the edge networks 21 and 22 includes plural layer-2 switches.

In FIG. 3, the core network 20 and the edge networks 21 and 22 constitute the virtual network corresponding to the bridge network in the related art.

User terminals or user networks not managed from the bridge network are connected to the layer-2 switches 21a, 22a of the edge networks 21 and 22, respectively. Because the layer-2 switches 21a, 22b are at the ends of the bridge network, they are referred to as “edge nodes” 21a, 22a. In addition, other layer-2 switches and MPLS switches are referred to as “relay nodes”, because they are not connected to terminals on the outside, but just relay traffic through the bridge network.

The edge nodes 21a, 22a are connected in a point-to-point manner. The path currently being used, below, referred to as “work path”, for example, passes through the layer-2 switches 21a, 21b, 21c, MPLS switches 20a, 20b, and the layer-2 switches 22b, 22c, 22a; the path in spare for protection, below, referred to as “protection path”, for example, passes through the layer-2 switches 21a, 21d, MPLS switches 20c, 20d, and the layer-2 switches 22d, 22a, thereby forming a protection path pair.

In the embodiment of the present invention, between the edge nodes 21a and 22a, the work path and the protection path can be switched quickly.

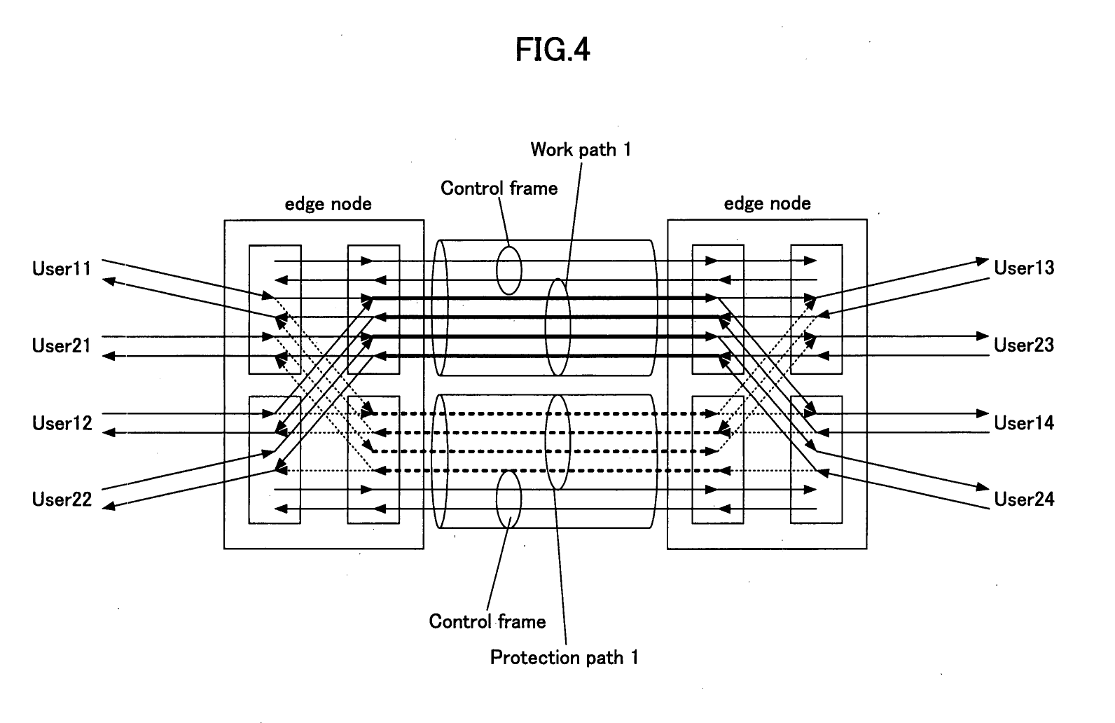

FIG. 4 is a diagram illustrating the path protection method according to the embodiment of the present invention.

As shown in FIG. 4, the terminals are connected in a point-to-point manner, and plural virtual network identifiers, specifically, VLANDID (Virtual Local Area Network IDentification), are collectively grouped, thereby setting a management VLANDID used as a single management virtual network identifier which is not in use in units of the groups. This management VLANDID is defined to be VGPP-ID (VLAN Group Path Protection ID), to perform redundancy setting in units of VGPP-ID (the work path and the protection path). In other words, redundancy switching is performed by transmitting the same control frame (CC frame: Continuity Check) through the work path 1 and the protection path 1 between the edge nodes 21a, 22a.

Edge Node Configuration

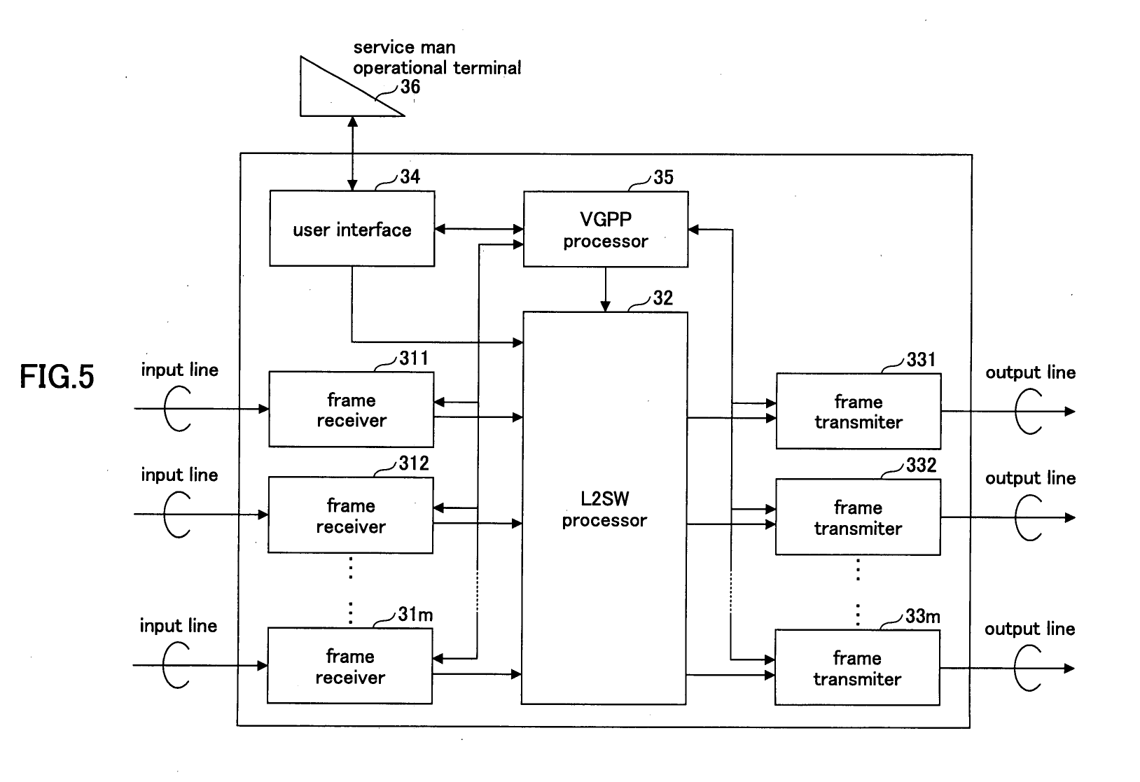

FIG. 5 is a block diagram illustrating a configuration of the edge node according to the present embodiment.

In FIG. 5, an edge node 30 includes receivers 311 through 31m, which have the functions of the layer-2 switch of the related art and receive frames from plural input lines, an L2SW processor 32 for processing operations of the layer-2 switches, and frame transmitters 331 to 33m which transmit the frames supplied from the L2SW processor 32 to plural output lines. In addition, a user interface 34 and a VGPP processor 35 constitute a VGPP processing functional portion. An operational terminal 36 for use of a service person is connected to the user interface 34.

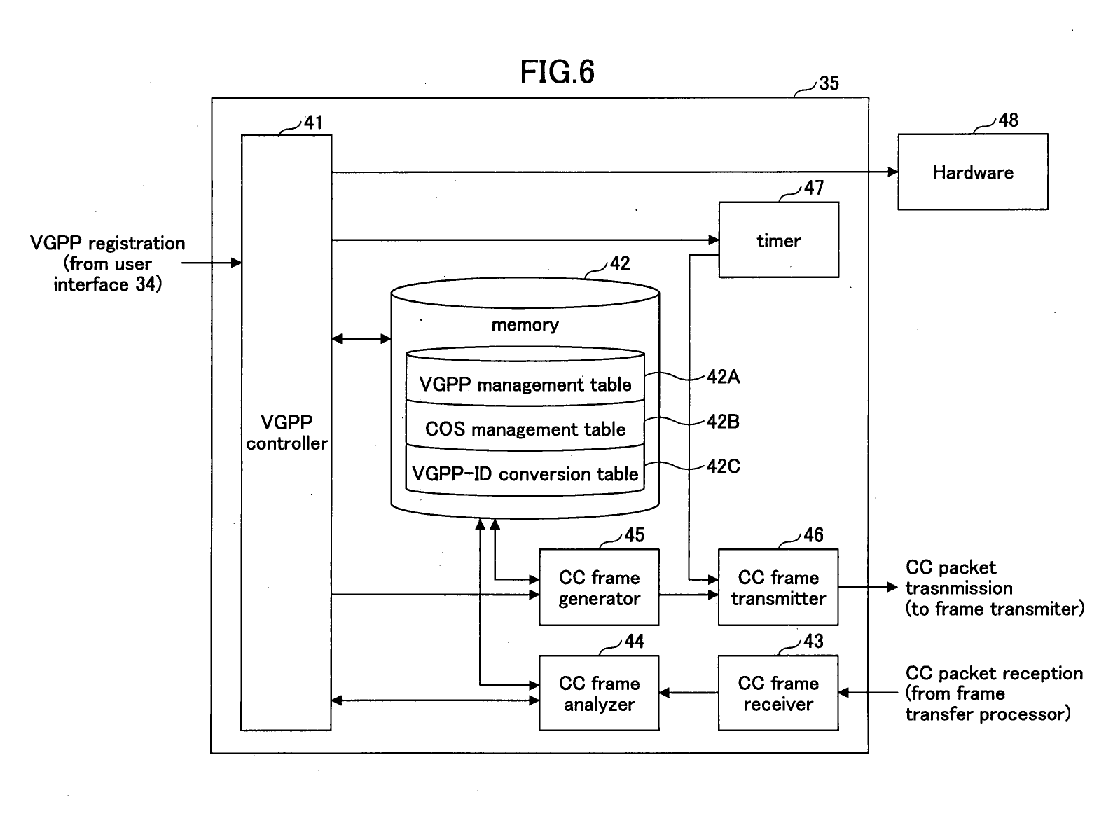

FIG. 6 is a block diagram illustrating a configuration of the VGPP processor 35 according to the present embodiment.

The VGPP processor 35 includes a VGPP controller 41, which control the overall operations of the VGPP processor 35; a memory 42 storing a VGPP management table 42A, a COS management table 42B, and a VGPP-ID conversion table 42C; a CC frame receiver 43 which receives the control frames; a CC frame analyzer 44 which analyzes the control frames; a CC frame generator 45 which generates the control frames; a CC frame transmitter 46 which transmits the control frames; and a timer 47.

When a service person shown in FIG. 5 executes a VGPP registration command from the operational terminal 36, the user interface 34 analyzes the input command and requests the VGPP controller 41 to carry out the VGPP registration. Thereby, the VGPP controller 41 carries out setting and registration in the VGPP management table 42A and the VGPP-ID conversion table 42C in the memory 42.

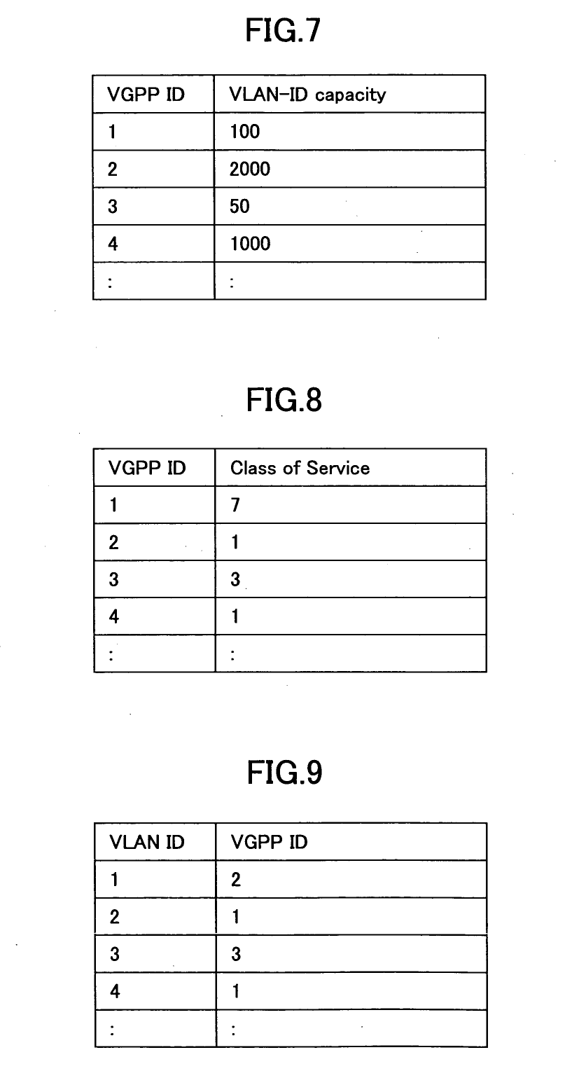

FIG. 7 exemplifies a VGPP management table 42A.

In the VGPP management table 42A, the numbers of VLAN-IDs are registered in connection with each of the VGPP IDs. Below, the number of VLAN is referred to as “VLAN-ID capacity”.

FIG. 8 exemplifies a COS management table 42B.

In the COS management table 42B, COS (Class of Service) is registered in connection with the VGPP IDs.

FIG. 9 exemplifies a VGPP-ID conversion table 42C.

In the VGPP-ID conversion table 42C, the VGPP-IDs are registered in connection with the VLAN-IDs.

The CC frame generator 45 generates the control frames which have the respective VGPP-IDs registered in the VGPP-ID conversion table 42C, and sends the control frames to the CC frame transmitter 46.

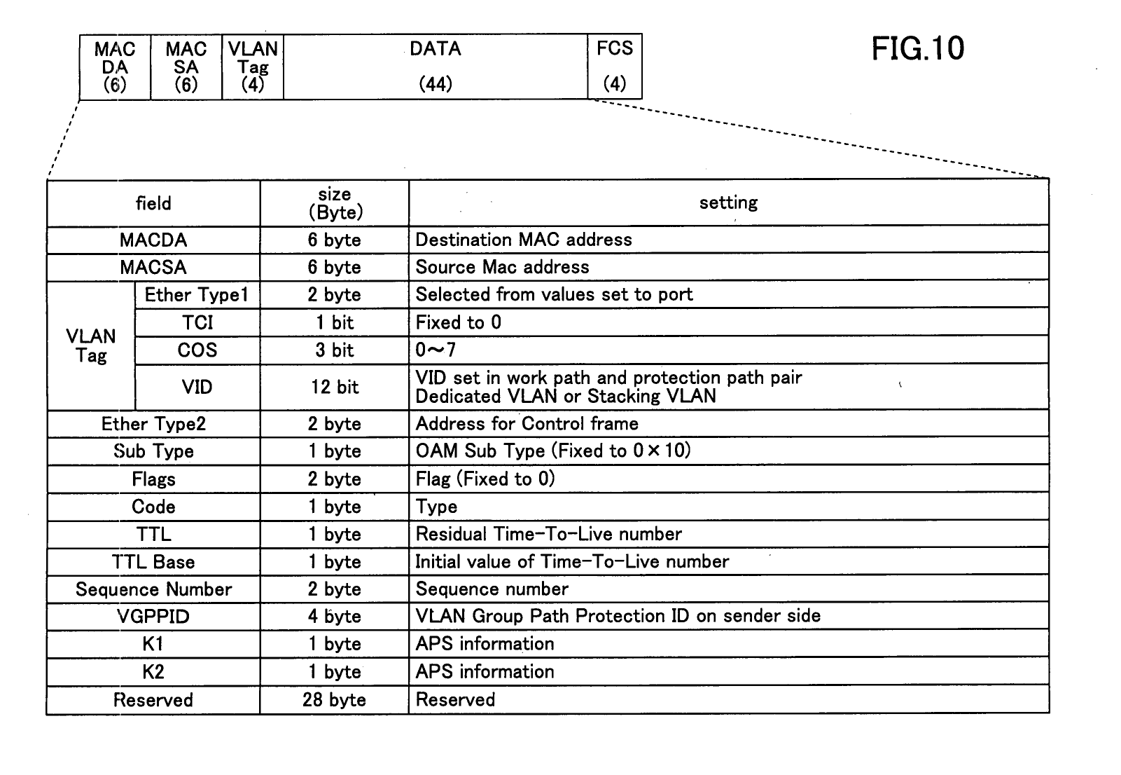

FIG. 10 is a table illustrating a format of the control frame.

In FIG. 10, in an MACDA line, a destination address MAC (MACDA) is assigned to be 0x01-00-0E-00-00-01, or others.

In an MACSA line, a source MAC address (MACSA) is assigned to have the MAC address of the edge node serving as a sender.

In a VLAN tag line, a parameter of an Ether type 1 may be an arbitrary value, with an initial value of 0x8100 being set to a port. COS is assigned to correspond to class levels 0 through 7. VID is assigned to have the VLAN-ID of the VLAN set for the pairs of the work path and the protection path. The Ether type 2 is assigned to have the address of 0xAA-AA.

In addition, when data following the path number (APS1, S2) change in the sequence number, the data are incremented and a number is set to indicate the change of the control protocol. Specifically, in a four-byte VGPP-ID, a VGPP-ID is set to express the path protection on the sending side (pairs of the work path and the protection path). In addition, in each of one-byte K1-byte and K2-byte, APS1, APS2 are set as the control protocol. Using the APS1, APS2, remote trouble notification and switching trigger are executed.

In each time period specified by the timer 47, the CC frame transmitter 46 supplies the above control frames from the frame transmitters 331 to 33m corresponding to the respective work path and the protection path to the CC frame analyzer 44. The CC frame analyzer 44 analyzes the received control frames, and sends the analysis results to the VGPP controller 41. At the same time, the CC frame analyzer 44 extracts the VGPP-ID and the service class COS in the control frame, and registers the service class COS in the COS management table 42B in the memory 42.

The VGPP controller 41 sets and registers the VGPP management table 42A, the COS management table 42B, and the VGPP-ID conversion table 42C in the memory 42.

From the analysis results of the received control frames, if it is determined that the reception state is a LOS state (signal termination) or indicates line trouble, the VGPP controller 41 performs redundancy switching from the work path side to the protection path side, and for this purpose, control of hardware 48 is executed. Here, the hardware 48 includes the receivers 311 through 31m, the L2SW processor 32, and the frame transmitters 331 to 33m as shown in FIG. 5.

When communicating the line trouble to an opposite edge node, the VGPP controller 41 directs generating a frame conforming to a control protocol so as to notify the CC frame generator 45 of the irregularity, and the VGPP controller 41 transmits the control frame to the CC frame transmitter 46.

In order not to communicate with the frame transmitter selected by the protection path, a blocking (close) control is executed, so that forwarding control (open) is performed only on the frame transmitter selected by the work path.

VGPP Registration

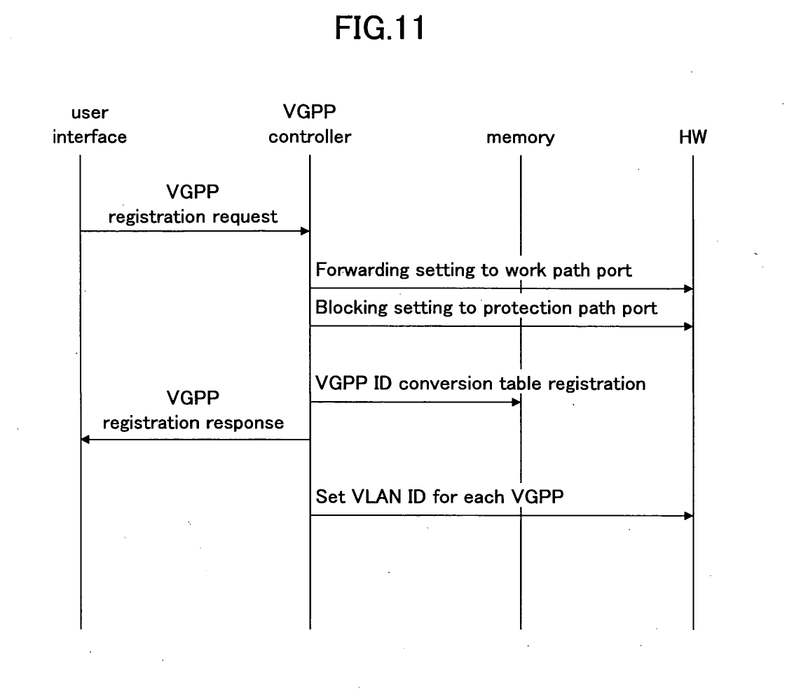

FIG. 11 is a sequence diagram illustrating the operation of registration of VGPP.

In FIG. 11, when the operational terminal 36 executes a VGPP registration command, the user interface 34 analyzes the input commands, and requests the VGPP controller 41 to carry out the VGPP registration.

Receiving the requests of VGPP registration, the VGPP controller 41 carries out forwarding setting in one of the frame receivers 311 through 31m and one of the frame transmitters 331 through 33m, which are selected to serve as ports of the work path, and carries out blocking setting in one of the frame receivers 311 through 31m and one of the frame transmitters 331 through 33m, which are selected to serve as ports of the protection path.

In addition, the VGPP controller 41 registers VLAN-ID and VGPP-ID in connection with each other in the VGPP-ID conversion table 42C, and requests the user interface 34 to make a VGPP registration response. Then, in connection to the VGPP-ID, the VGPP controller 41 controls switch setting of the L2SW processor 32 in terms of the grouped VLAN-ID.

In FIG. 9, VLAN-IDs=2, 4 are mapped to the group with VLAN-ID=1.

Here, the VGPP processor 35 of the end node on the transmitting side periodically transmits the control frames, and the VGPP processor 35 of the end node on the corresponding receiving side receives and confirms the control frames to check the communications on the path, and thereby, problems of the relay node can be coped with.

In the process on the transmitting side, the control frames including system selection and link states in units of VGPP are created, and are transmitted at regular intervals Ttx. In addition, in the process on the receiving side, information included in the control frames received under normal conditions is compared to the information on the present node.

If the control frames cannot be received over the specified interval Ttx (for example 100 ms) for several times, for example over a protection time (such as three times), it is determined that this link is not usable, and switching ought to be performed if it is possible. In addition, the switching is performed with RDI (Remote Defect Indication) notification or the switching trigger by the control protocol APS1 and APS2 of the received control frames.

Control Frame Reception

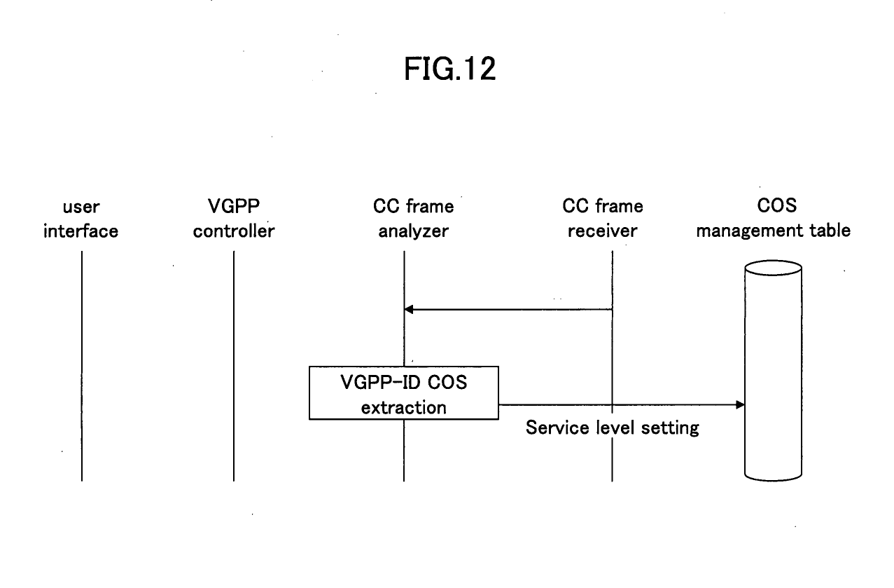

FIG. 12 is a sequence diagram illustrating reception of the control frame.

In FIG. 12, the CC frame receiver 43 supplies the received control frames to the CC frame analyzer 44. The CC frame analyzer 44 extracts the VGPP-ID and the service class COS in the control frame, and registers the service class COS in the COS management table 42B in the memory 42 in connection with each VGPP-ID.

If the control frames having the same VGPP-ID are not received over a specified time interval Ttx (for example 100 ms) over N protection times (for example, N=three), the CC frame analyzer 44 recognizes that LOC (Loss Of CC) has occurred.

If the values of the K1-byte and the K2-byte stored in the K1-byte and the K2-byte in the received control frame are different, the CC frame analyzer 44 recognizes that line trouble has occurred, and notifies the VGPP controller 41 of the trouble information obtained by analysis.

The VGPP controller 41, which receives the analysis results of the trouble information, executes the VGPP switching sequence, as described below, and notifies the operational terminal 36 from the user interface 34.

The indications of trouble detection may include LOC, APS (switching direction) reception, trouble with or removal of cards having ports including the work path and protection path, shielding of light input to the ports including the work path and protection path, 10B8B transformation errors, frequent occurrence of FCS errors, trouble with and removal of SFP (Small Form Factor Pluggable) modules or other physical reasons, or operator switching requests.

First Example of Path Switching

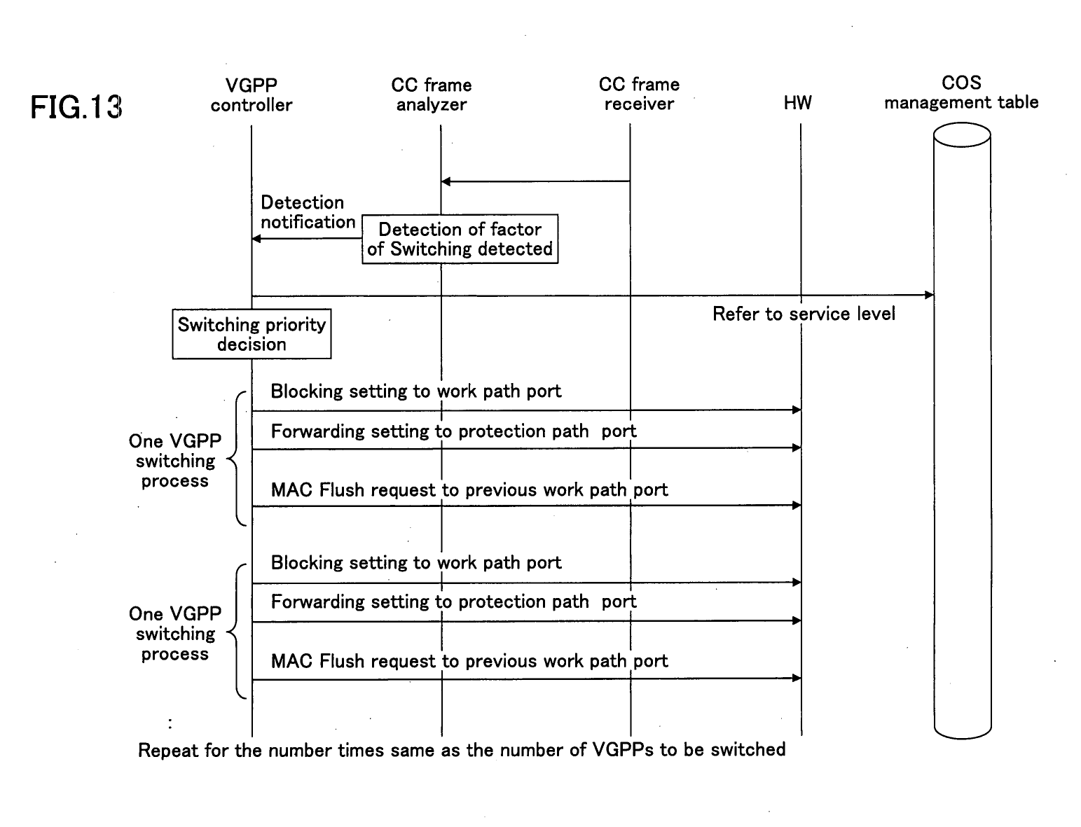

FIG. 13 is a sequence diagram illustrating an example of path switching according to the present embodiment.

In FIG. 13, the CC frame receiver 43 supplies the received control frames to the CC frame analyzer 44. If the CC frame analyzer 44 detects abnormal states in units of VGPP-ID (LOC detection, changes of K1, K2 bytes), the CC frame analyzer 44 notifies the VGPP controller 41.

In response to the factors causing the path switching, the VGPP controller 41 selects a VGPP-ID of the redundancy switching. When there are plural VGPP-IDs of redundancy switching, the COS management table 42B is referred to; then the preferential order of the VGPP-IDs of redundancy switching is determined in descending order of the service class COS.

Then, from the VGPP-ID having the highest switching priority, the VGPP controller 41 carries out forwarding setting sequentially in one of the frame receivers 311 through 31m and one of the frame transmitters 331 through 33m, which are selected to serve as a new protection path, and carries out blocking setting in one of the frame receivers 311 through 31m and one of the frame transmitters 331 through 33m, which are selected to serve as ports of a new work path. With the new work path (the old protection path), the obtained MAC entry information (flash) is deleted to execute the redundancy switching. The redundancy switching is performed for a number of times equaling to the number of the VGPP-IDs.

Control Frame Transmission

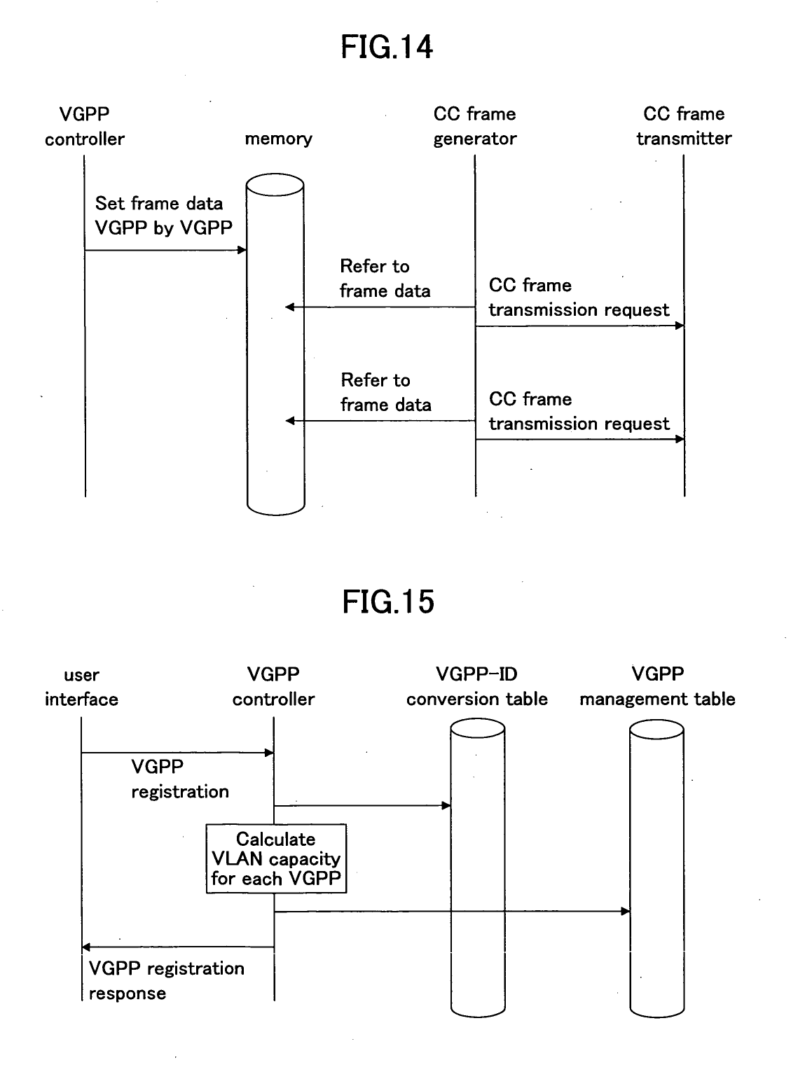

FIG. 14 is a sequence diagram exemplifying transmission of the control frame.

In FIG. 14, the VGPP controller 41 manages the values in the K1 byte and K2 byte in each VGPP-ID. The CC frame generator 45 refers to the memory 42 to read the values in the K1 byte and K2 byte and sets them in the control frame, so as to notify a corresponding device of a line problem. Data other than this use the control frames stored in the inner memory, and with this information being set in the control frame, a control frame having the format as shown in FIG. 10 is generated and is sent to the CC frame transmitter 46. The CC frame transmitter 46 receives periodic signals from the timer 47 (for example, a period of 100 ms), the CC frame transmitter 46 sends the control frame to a corresponding frame transmitter.

In this way, between the edge nodes 21a and 22a, the redundancy switching can be performed quickly in units of VGPP; further, when there are plural VGPP-IDs of redundancy switching, as the redundancy switching is performed in descending order of the service class COS, VGPP of a large service class COS value and higher priority can be switched at a high speed, and the switching efficiency can be improved.

VGPP Management Table Setting

FIG. 15 is a sequence diagram illustrating the operations of setting the VGPP management table in VGPP registration.

In FIG. 15, when a service person executes a VGPP registration command from the operational terminal 36, the user interface 34 analyzes the input command, and requests the VGPP controller 41 to execute the VGPP registration.

The VGPP controller 41 registers VLAN-IDs and the corresponding VGPP-ID in the VGPP-ID conversion table 42C in the memory 42.

In addition, the VLAN-ID capacities of each of the VGPP-IDs are registered in the VGPP management table 42A. Then, a VGPP registration response is sent to the user interface 34.

Although not illustrated in FIG. 15, similar to FIG. 11, the VGPP controller 41 carries out forwarding setting in one of the frame receivers 311 through 31m and one of the frame transmitters 331 through 33m, which are selected to serve as ports of the work path, and carries out blocking setting in one of the frame receivers 311 through 31m and one of the frame transmitters 331 through 33m, which are selected to serve as ports of the protection path. Then, in connection to the VGPP-IDs, the VGPP controller 41 controls switch setting of the L2SW processor 32 in terms of the grouped VLAN-ID.

### Second Example of Path Switching

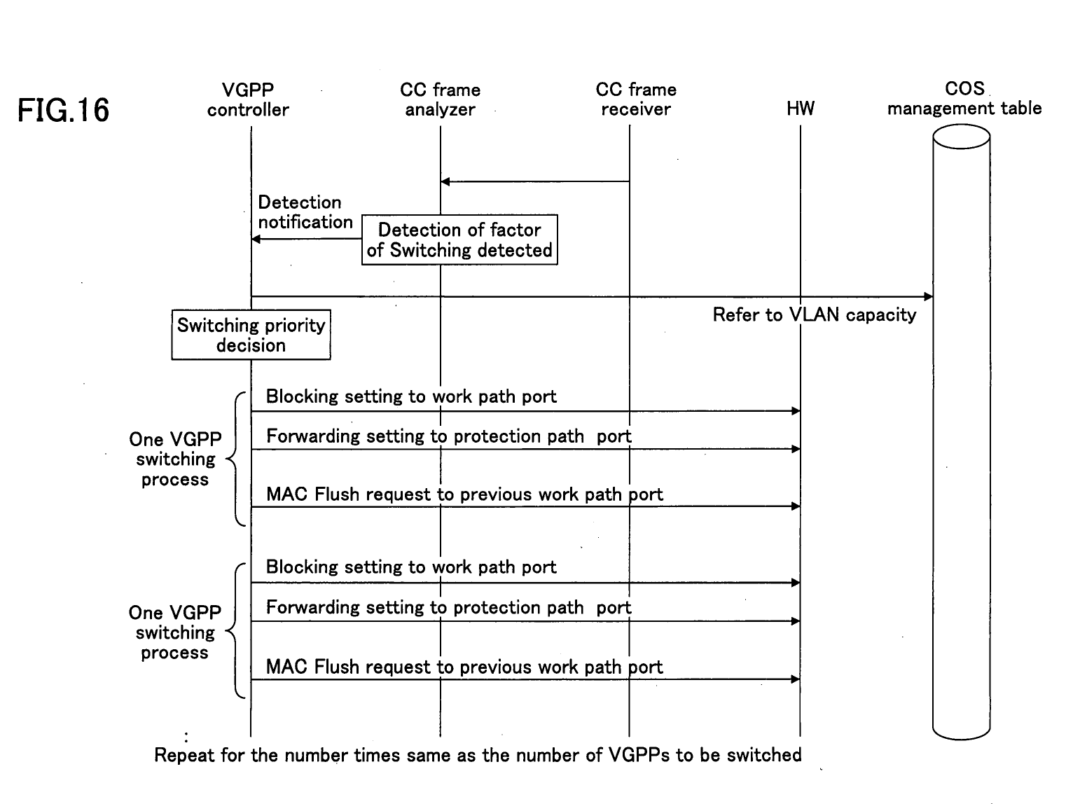

FIG. 16 is a sequence diagram illustrating another example of path switching according to the embodiment of the present invention.

In FIG. 16, the CC frame receiver 43 supplies the received control frames to the CC frame analyzer 44. If the CC frame analyzer 44 detects abnormal states in units of VGPP-ID (LOC detection, changes of K1, K2 bytes), the CC frame analyzer 44 notifies the VGPP controller 41 of the anomaly.

In response to the factors causing the path switching, the VGPP controller 41 selects a VGPP-ID of the redundancy switching to be executed. When there are plural VGPP-IDs of redundancy switching, the VGPP management table 42A is referred to, and the preferential order of the VGPP-IDs of redundancy switching is determined in descending order of the service class COS.

Then, from the VGPP-ID having the highest priority, the VGPP controller 41 carries out forwarding setting sequentially in one of the frame receivers 311 through 31m and one of the frame transmitters 331 through 33m, which are selected to serve as a new protection path, and carries out blocking setting sequentially in one of the frame receivers 311 through 31m and one of the frame transmitters 331 through 33m, which are selected to serve as ports of a new work path. With the new work path (the old protection path), the learned MAC entry information (flash) is deleted to execute the redundancy switching. The redundancy switching is performed for a number of times equaling to the number of the VGPP-IDs.

In this way, between the edge nodes 21a and 22a, the redundancy switching can be performed at a high speed in units of VGPP; further, when there are plural VGPP-IDs of redundancy switching, as the redundancy switching is performed in descending order of the VLAN-ID capacity, VGPP of a large VLAN-ID capacity can be switched at high speed, and the switching efficiency can be improved.

According to the present invention, the concept of VGPP, that is, grouped plural VLANs, is introduced so that the redundancy switching can be performed in units of VGPP, thus realizing high speed switching. This enables construction of a network of scalability at low cost. Further, because it is possible to analyze the control frames and register the service level COS corresponding to each VGPP in the COS management table 42B, or register the VLAN-ID capacity in the VGPP controller 41 to control the switching sequence of plural VGPP, it is possible to further improve the VGPP switching efficiency, and provide high quality switching functions.

Here, for example, the CC frame generator 45 and the CC frame transmitter 46 correspond to the “control frame generation unit” in claims; the CC frame receiver 43, the CC frame analyzer 44, and the VGPP controller 41 correspond to the “switching unit” in claims; the COS management table 42B corresponds to the “service class management table” in claims; and the VGPP management table 42A corresponds to the “virtual network identifier management table” in claims.

While the invention has been described with reference to specific embodiments chosen for purpose of illustration, it should be apparent that the invention is not limited to these embodiments, but numerous modifications could be made thereto by those skilled in the art without departing from the basic concept and scope of the invention.

This patent application is based on Japanese Priority Patent Application No. 2005-378371 filed on Dec. 28, 2005, the entire contents of which are hereby incorporated by reference.

What is claimed is:

1. A path protection method used in switching a currently-used path and a spare path in an interval in point-to-point connection in a virtual network, comprising the steps of:
associating a virtual network identifier assigned to one or more users with a virtual network identifier for management, said virtual network identifiers being regarded as one path to set a path for current use and a spare path; and
when switching the currently-used path and the spare path, according to service class information included in the virtual network identifier for management, a path corresponding to a virtual network identifier for management having a higher service class than other paths is preferentially switched to.

2. A path protection method used in switching a currently-used path and a spare path in an interval in point-to-point connection in a virtual network, comprising the steps of:
associating a virtual network identifier assigned to one or more users with a virtual network identifier for management, said virtual network identifiers being regarded as one path to set a path for current use and a spare path; and
when switching the currently-used path and the spare path, a path having a larger number of virtual network identifiers than other paths is preferentially switched to.

3. A layer-2 switch, comprising:
a control frame generation unit configured to generate a control frame and send the same to a currently-used path and a spare path, said control frame having a virtual network identifier for management, the virtual network identifier assigned to one or more users being associated with a virtual network identifier for management so as to be regarded as one path; and
a switching unit configured to check communications between the currently-used path and the spare path by receiving the control frame, and to switch the currently-used path to the spare path when trouble is detected in the currently-used path;
wherein
according to service class information included in the control frame, the switching unit preferentially switches to a path corresponding to a virtual network identifier for management having a higher service class than other paths.

4. A layer-2 switch, comprising:
a control frame generation unit configured to generate a control frame and send the same to a currently-used path and a spare path, said control frame having a virtual network identifier for management, the virtual network identifier assigned to one or more users being associated with a virtual network identifier for management so as to be regarded as one path; and
a switching unit configured to check communications between the currently-used path and the spare path by receiving the control frame, and to switch the currently-used path to the spare path when trouble is detected in the currently-used path;
wherein
when switching the currently-used path and the spare path, the switching unit preferentially switches to a path having a larger number of virtual network identifiers than other paths.

5. The layer-2 switch as claimed in claim 3, further comprising:
a service class management table including the virtual network identifier for management extracted from the received control frame and the service class information.

6. The layer-2 switch as claimed in claim 4, further comprising:
a virtual network identifier management table including the number of the virtual network identifiers associated with the virtual network identifier for management.

7. The layer-2 switch as claimed in claim 3, wherein the control frame includes a control protocol.

8. The layer-2 switch as claimed in claim 4, wherein the control frame includes a control protocol.

9. The layer-2 switch as claimed in claim 3, wherein the switching unit sends out the control frame at regular intervals to check communications.

10. The layer-2 switch as claimed in claim 4, wherein the switching unit sends out the control frame at regular intervals to check communications.

11. The layer-2 switch as claimed in claim 9, wherein the switching unit detects the trouble in the currently-used path when the switching unit fails to receive the control frame from the currently-used path and the spare path for a predetermined number of reception operations.
